(19) United States
(12) Patent Application Publication
(10) Pub. No.: US 2026/0292773 A1
(43) Pub. Date: Sep. 24, 2026

(54) Device-To-Device Message Forwarding Mechanism with Positioning Protocol

(71) Applicant: MEDIATEK INC., Hsin-Chu (TW)

(72) Inventor: Nathan Edward Tenny, San Jose, CA (US)

(73) Assignee: MEDIATEK INC., Hsin-Chu (TW)

(21) Appl. No.: 19/475,070

(22) PCT Filed: Sep. 13, 2024
(86) PCT No.: PCT/CN2024/118694

§ 371 Date: Oct. 14, 2025

Related U.S. Application Data
(60) Provisional application No. 63/584,915, filed on Sep. 25, 2023.

(51) Int. Cl. H04W 64/00; H04W 4/12; H04W 92/18

(52) U.S. Cl. CPC H04W 64/00; H04W 4/12; H04W 92/18

(57) ABSTRACT

A method of message forwarding in a wireless system includes receiving a first message by a first node from a second node. The first message includes a message body and an identifier for a third node. The method further includes identifying the third node as a destination by the first node according to the identifier for the third node, and transmitting a second message by the first node to the third node. The second message includes information associated with the first message and an identifier for the second node as a source. The first message and the second message are constructed using Sidelink Positioning Protocol (SLPP) or Ranging and Sidelink Positioning Protocol (RSPP).

### CROSS REFERENCE TO RELATED APPLICATION

This application claims the benefit of U.S. Provisional Application No. 63/584,915, filed on Sep. 25th, 2023. The content of the application is incorporated herein by reference.

### TECHNICAL FIELD

The present disclosure relates to wireless communications, and more particularly to communication among a plurality of devices engaged in a positioning operation on a sidelink interface.

### BACKGROUND

In modern wireless systems, such as 3 5G cellular networks, there is increasing support for device-to-device (D2D) communication capabilities. These capabilities allow user equipments (UEs) to engage in direct communication without the intervention of network infrastructure nodes. This direct communication interface is known by various names, including sidelink, PC5, short-range communication (SRC), or peer-to-peer interface. One of the significant advantages of this direct communication capability is that it enables the determination of UE locations and inter-UE distances through a process called sidelink positioning.

Sidelink positioning operates based on the transmission and measurement of specific signals known as sidelink positioning reference signals (SL-PRS) on the sidelink interface. While this technique can be used in combination with device-to-network measurements, such as those performed over the 3GPP Uu interface in what is termed a joint PC5/Uu positioning operation, the primary focus of this discussion is on the sidelink positioning aspects of such operations.

The current implementation of the sidelink positioning faces several critical challenges that impede its optimal performance in modern wireless communication systems. The challenges encompass restricted node-to-node communication, inflexible message structuring, problems synchronizing data from various origins, difficulties scaling in extensive networks, poor adaptation to changing network environments, and hurdles in deploying across diverse network types. Most critically, in topologies where direct connections between all nodes are not always possible, message routing and network management can be significantly complicated. Collectively, these challenges hinder the protocol's efficiency, scalability, and reliability, particularly in scenarios involving multiple devices. Addressing these issues is crucial for enhancing the protocol's effectiveness and ensuring its suitability for next-generation wireless communication systems, where precise and secure sidelink positioning is increasingly important.

### SUMMARY

An embodiment discloses a method of message forwarding in a wireless system. The method comprises receiving a first message by a first node from a second node. The first message comprises a message body and an identifier for a third node. The method further comprises identifying the third node as a destination by the first node according to the identifier for the third node, and transmitting a second message by the first node to the third node. The second message comprises information associated with the first message and an identifier for the second node as a source. The first message and the second message are constructed using Sidelink Positioning Protocol (SLPP) or Ranging and Sidelink Positioning Protocol (RSPP).

Another embodiment discloses a method of message forwarding in a wireless system. The method comprises receiving a first message by a first node from a second node. The first message comprises a message body and an identifier for a third node. The method further comprises initiating a countdown upon receipt of the first message by the first node, identifying the third node as a destination by the first node according to the identifier for the third node, and transmitting a second message by the first node to the third node when the countdown completes. The second message comprises information associated with the first message and an identifier for the second node as a source. The first message and the second message are constructed using Sidelink Positioning Protocol (SLPP) or Ranging and Sidelink Positioning Protocol (RSPP).

An embodiment discloses a user equipment (UE) comprising a memory and a processor coupled to the memory. The processor is used to receive a first message from a second node, identify a third node as a destination, and transmit a second message to the third node. The first message and the second message are constructed using Sidelink Positioning Protocol (SLPP) or Ranging and Sidelink Positioning Protocol (RSPP). The first message comprises a message body and an identifier for the third node as the destination. The second message comprises information associated with the first message and an identifier for the second node as a source.

Another embodiment discloses a user equipment (UE) comprising a memory and a processor coupled to the memory. The processor is used to receive a first message from a second node, initiate a countdown upon receipt of the first message, identify a third node as a destination, and transmit a second message to the third node when the countdown completes. The first message and the second message are constructed using Sidelink Positioning Protocol (SLPP) or Ranging and Sidelink Positioning Protocol (RSPP). The first message comprises a message body and an identifier for the third node. The second message comprises information associated with the first message and an identifier for the second node as a source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an embodiment of a wireless system.

FIG. 2 illustrates another embodiment of a wireless system.

FIG. 3 illustrates another embodiment of a wireless system based on the wireless system of FIG. 1.

FIG. 4 illustrates another embodiment of a wireless system based on the wireless system of FIG. 2.

FIG. 5 illustrates an embodiment of an SLPP forwarding mechanism.

FIG. 6 illustrates an alternative embodiment of an SLPP forwarding mechanism.

FIG. 7 illustrates an alternative embodiment of an SLPP forwarding mechanism.

FIG. 8 illustrates an alternative embodiment of an SLPP forwarding mechanism.

FIG. 9 illustrates a timer-based approach for optimizing the SLPP forwarding mechanism.

FIG. 10 illustrates a simplified block diagram of wireless devices according to the embodiments.

### DETAILED DESCRIPTION

The present disclosure pertains to wireless communication systems and methods, with a primary focus on 3GPP-based systems, but its applicability extends beyond these specific implementations. Those skilled in the art will recognize that the techniques, apparatus, and systems described herein can be practiced without certain specific details, which have been omitted for clarity. Well-known methods, procedures, components, and circuits are not described in exhaustive detail to avoid obscuring the core concepts presented.

This disclosure is particularly applicable to various wireless multiple access systems. Such systems include, but are not limited to, Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and Multi-Carrier Frequency Division Multiple Access (MC-FDMA) systems. Each of these multiple access systems can be implemented through specific radio technologies.

For instance, CDMA may be realized through radio technologies such as Universal Terrestrial Radio Access (UTRA) or CDMA2000. TDMA finds implementation in radio technologies like Global System for Mobile communications (GSM), General Packet Radio Service (GPRS), or Enhanced Data rates for GSM Evolution (EDGE). OFDMA can be implemented via wireless technologies including Institute of Electrical and Electronics Engineers (IEEE) 802.11 (Wi-Fi), IEEE 802.16 (WiMAX), IEEE 802.20, or Evolved UTRA (E-UTRA).

It is important to note that UTRA is a component of the Universal Mobile Telecommunications System (UMTS). The 3rd Generation Partnership Project (3GPP) Long-Term Evolution (LTE) is part of Evolved UMTS (E-UMTS), which utilizes E-UTRA. In the context of 3GPP LTE, OFDMA is employed for downlink (DL) transmissions, while SC-FDMA is used for uplink (UL) transmissions. The evolution of 3GPP LTE encompasses several iterations, including LTE-Advanced (LTE-A), LTE-A Pro, and 5G New Radio (NR).

While the embodiments described in this specification primarily relate to 3GPP-based wireless communication systems, the technical characteristics presented are not limited to these systems. The principles and methods discussed can be adapted and applied to other wireless communication systems that may not strictly adhere to 3GPP standards.

In 3GPP and other wireless communication standards, various radio access networks (RANs) are utilized to facilitate communication between base stations (which may be referred to as RAN nodes, network nodes, or simply nodes) and wireless communication devices known as user equipments (UEs). These RANs can include, but are not limited to, Global System for Mobile communications (GSM), Enhanced Data rates for GSM Evolution (EDGE) RAN (GERAN), Universal Terrestrial Radio Access Network (UTRAN), Evolved Universal Terrestrial Radio Access Network (E-UTRAN), and Next-Generation Radio Access Network (NG-RAN).

In 3GPP standards, the Sidelink Positioning Protocol (SLPP), which may also be referred to as the Ranging and Sidelink Positioning Protocol (RSPP), is a specialized communication protocol designed for facilitating positioning operations in cellular networks, particularly in scenarios involving device-to-device (D2D) or sidelink communications. SLPP plays a crucial role in enabling and coordinating various sidelink-positioning-related functions among UEs and network entities such as the Location Management Function (LMF).

The sidelink positioning process typically involves UEs operating in two roles: a target UE, whose location is sought by the system, and one or more anchor UEs, which serve as reference points for determining the location of the target. In the case of ranging operations, where the goal is to determine the distance between two UEs, the system may model the scenario in different ways. For instance, it could treat both UEs as targets, or consider one as a target and the other as an anchor. In addition to the target UE and the anchor UE, a sidelink positioning operation may involve a UE in a third “server” role, which is described below.

A variety of sidelink positioning methods have been developed to cater to different scenarios and requirements. These methods include sidelink time difference of arrival (SL-TDOA), sidelink relative time of arrival (SL-RTOA), sidelink angle of arrival (SL-AoA), and sidelink roundtrip time (SL-RTT). While these methods differ in their specific approaches, they all share a common foundation: the target's location is computed using measurements of the SL-PRS.

The exact nature of SL-PRS transmission and measurement depends on the positioning method in use. In some cases, the target UE may transmit the SL-PRS, which is then received and measured by the anchor UE(s). In other cases, the reverse may occur, with anchor UEs transmitting and the target UE measuring. Some methods may involve bidirectional transmission and measurement. Regardless of the specific approach, the resulting SL-PRS measurements typically comprise information about various signal characteristics. This information may include data on timing, angle, phase, and/or signal strength of the received SL-PRS.

Once these measurements are collected, they are delivered to a server for processing and interpretation. This server can take different forms depending on the specific implementation. In some cases, it may be a distinguished UE referred to as a server UE, which may have, for example, the capability to interpret the SL-PRS measurements and form a location estimate for the target UE and/or a range estimate between two involved UEs. The server UE might be the same as the target UE or one of the anchor UEs, or it could be a separate UE in communication with some subset of the target and anchor UEs.

In other scenarios, particularly when one or more UEs are within coverage of a cellular network, the computation of the location estimate may be performed by a network entity known as a location management function (LMF). The LMF is a server in the network that has the ability to coordinate assistance data and measurements, and potentially to compute a location estimate based at least in part on SL-PRS measurements. For the purposes of this discussion, the term “server” is used generically to refer to either a server UE or an LMF.

Communication between the involved UEs and the server is facilitated by a specialized protocol known as the Sidelink Positioning Protocol (SLPP), which may also be referred to as the Ranging and Sidelink Positioning Protocol (RSPP). SLPP comprises a variety of messages, which may be sent from a UE in one functional role (target/anchor/server) to another UE (typically in a different functional role). SLPP can also be used for communication between a UE involved in sidelink positioning and an LMF. This protocol is designed to be flexible and can be transported over a variety of lower protocol layers between the endpoints.

However, in some embodiments, a significant challenge arises: the server may not be able to perform direct communication with all the involved UEs. The meaning of “direct communication” varies depending on the type of server. In the case of an LMF, direct communication refers to communication through the cellular system's air interface, typically involving wireless communication between a UE and a base station, which is then coupled by one or more network interfaces to the LMF. For a server UE, direct communication refers to communication over the sidelink interface itself.

It should be noted that the anchor and target UEs are expected to be in direct communication, as they need to receive and measure one another UE's SL-PRS transmissions. Therefore, the communication challenges primarily apply to interactions involving the server. However, in some cases, these methods may also need to be applied to communication between a target UE and an anchor UE, or between two anchor UEs.

In scenarios where direct communication with the server is not possible for all involved UEs, it becomes necessary to implement a mechanism for forwarding information contained in SLPP messages through intermediate nodes. The development of efficient, reliable, and secure forwarding mechanisms for sidelink positioning information represents a significant challenge in the field. Addressing this challenge is crucial for enabling accurate positioning in a wide range of scenarios, particularly those where direct communication between all parties is not feasible due to range limitations, network coverage issues, or other constraints.

SLPP is structured to support a range of positioning-related transactions and message types. These may include, but are not limited to, capability exchange, assistance data transfer, location information transfer, and error indication. Each of these transaction types serves a specific purpose in the positioning process. For example, capability exchange allows devices to inform each other or the network about their positioning-related capabilities, while assistance data transfer enables the sharing of information that can aid in more accurate positioning calculations. The protocol is designed to be flexible and extensible, allowing for the incorporation of various information elements and/or metadata within its messages. These elements can be structured using standardized formats such as Abstract Syntax Notation One (ASN.1), which provides a consistent way of encoding and decoding message contents across different implementations and devices.

SLPP messages typically contain key components such as transaction type identifiers, source and destination information, and message bodies carrying the actual payload data. One of the key features of SLPP is its ability to handle complex communication patterns, including one-to-many and many-to-one scenarios, which is particularly useful in sidelink positioning operations where multiple devices may need to coordinate their activities or share information simultaneously.

For terms and techniques not explicitly defined or described within this specification, readers are directed to consult wireless communication standard documents (e.g., 3GPP Specifications) that were issued prior to this disclosure. These documents provide comprehensive definitions and explanations of relevant terminology and technologies.

It is important to note that while this discussion frequently employs 5G terminology, this usage is not intended to be limiting. Alternative nomenclature may be used in various implementations to refer to nodes and/or interfaces that serve similar purposes to those described herein. The principles and methods discussed are adaptable to future generations of wireless communication technologies beyond 5G.

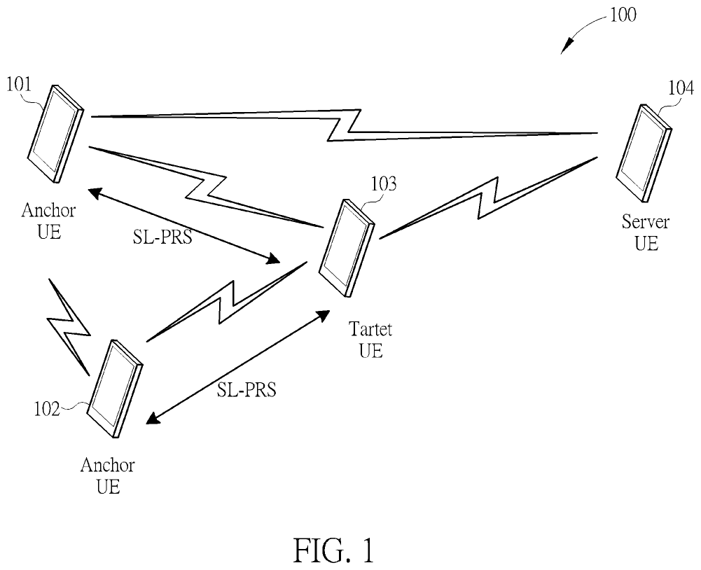

FIG. 1 illustrates an embodiment of a wireless system 100 featuring multiple User Equipment (UE) devices capable of sidelink positioning. The wireless system 100 comprises two anchor UEs 101 and 102, a target UE 103, and a server UE 104, with the server being distinct from the other UEs. The target UE 103 can directly communicate with both anchor UEs 101 and 102 and the server UE 104. The server UE 104 has direct communication links with the target UE 103 and anchor UE 101, but not with the anchor UE 102. The two anchor UEs 101, 102 can communicate directly with each other and the target UE 103, while the anchor UE 101 also maintains a direct link with the server UE 104. Sidelink Positioning Reference Signals (SL-PRS) may be transmitted by the anchor UEs 101 and 102 and/or the target UE 103 over the sidelink interface. Although FIG. 1 shows bidirectional transmission of SL-PRS, it is important to note that this may occur only from anchors to target or vice versa.

It should be noted that UEs transmitting SL-PRS are termed SL-PRS Tx UEs, while those receiving and measuring SL-PRS are called SL-PRS Rx UEs. In some cases, a single UE may function as both an SL-PRS Tx and Rx UE.

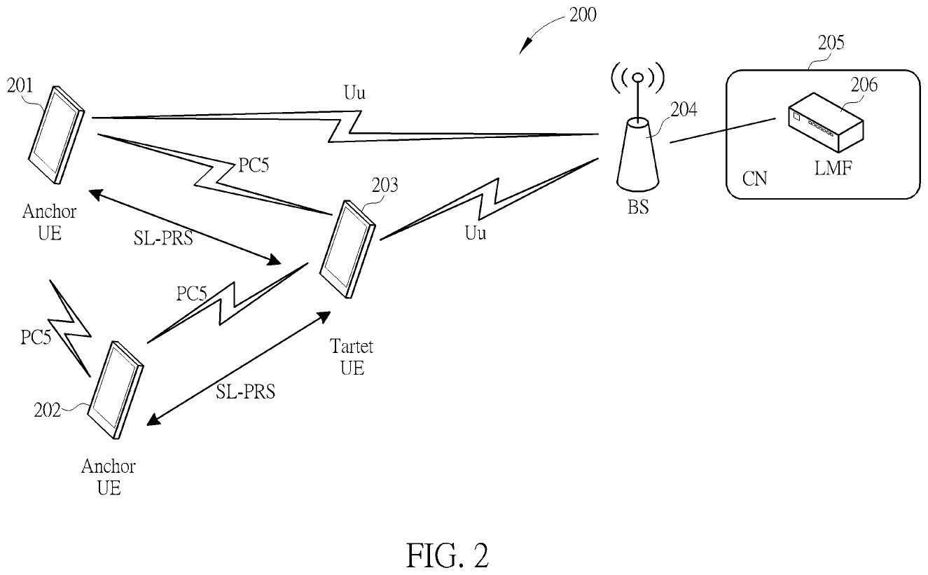

FIG. 2 illustrates an embodiment of a wireless system 200. The wireless system 200, as depicted, includes two anchor UEs 201 and 202, a target UE 203, a base station (BS) 204, and a core network (CN) 205. The CN 205 includes a location management function (LMF) 206. It is to be understood that other nodes of the CN 205, while not explicitly shown, may be present. The BS 204 is communicatively coupled to the LMF 206, with the connection potentially traversing other CN nodes such as an access and mobility management function (AMF), which are omitted from the figure for clarity. The nodes of the CN 205 may communicate via a service bus.

In the illustrated configuration, the two anchor UEs 201 and 202 are capable of direct communication over a PC5 interface. The target UE 203 can communicate directly with the anchor UEs 201, 202 over a PC5 interface and with the BS 203 over a Uu interface. Additionally, the anchor UE 201 can communicate directly with the BS 203 over a Uu interface. It is noteworthy that the BS 204 lacks direct communication capability with the anchor UE 202, which may be attributed to the anchor UE 202 being outside the coverage area of the BS 204. It is assumed that any UE capable of direct communication with the BS 204 can also communicate with the LMF 206, for example, for the purpose of exchanging SLPP signaling.

A common challenge observed in both FIG. 1 and FIG. 2 is the inability of the server (whether a UE or LMF) to communicate directly with the anchor UE 202. This limitation poses potential obstacles for effective sidelink positioning, which may require the server to ascertain the capabilities of the anchor UE 202, exchange assistance data, retrieve SL-PRS measurement results, and perform other necessary operations.

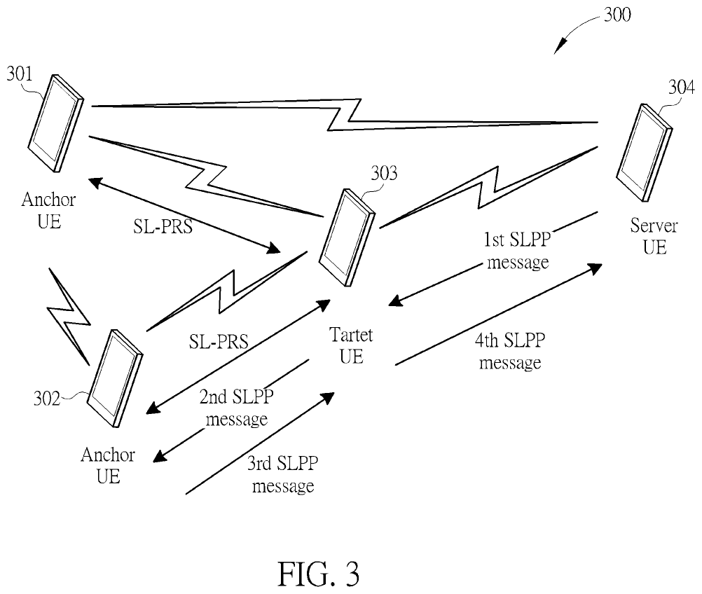

To address this challenge, FIG. 3 illustrates a wireless system 300 showing a high-level solution based on the wireless system 100 depicted in FIG. 1. In this solution, the target UE 303 assumes a role in forwarding information between the server UE 304 and the anchor UE 302. This forwarding process is executed through a series of steps:

In the first step, the server UE 304 transmits a first SLPP message to the target UE 303. This message contains first information explicitly directed to the anchor UE 302. Subsequently, the target UE 303 sends a second SLPP message to anchor UE 302, conveying the aforementioned first information. The next step involves the anchor UE 302 sending a third SLPP message to the target UE 303. This message comprises second information intended for the server UE 304. In the final step, the target UE 303 transmits a fourth SLPP message to the server UE 304, containing the second information received from the anchor UE 302.

This sequence of message exchanges enables the server UE 304 to effectively communicate with the anchor UE 302, overcoming the limitation of direct communication. Such a mechanism enhances the flexibility and robustness of the sidelink positioning system, allowing for more comprehensive and efficient positioning operations in scenarios where direct communication between all nodes is not feasible.

The present disclosure relates to methods and systems for forwarding SLPP messages in cellular networks where direct communication between all nodes is not feasible. Various embodiments are described to facilitate efficient information exchange between network entities, particularly in scenarios involving a server (which may be a Location Management Function or a server User Equipment), anchor UEs, and a target UE. These methods address the common challenge of enabling communication between network elements that lack direct connectivity, thereby enhancing the overall functionality and efficiency of sidelink positioning systems.

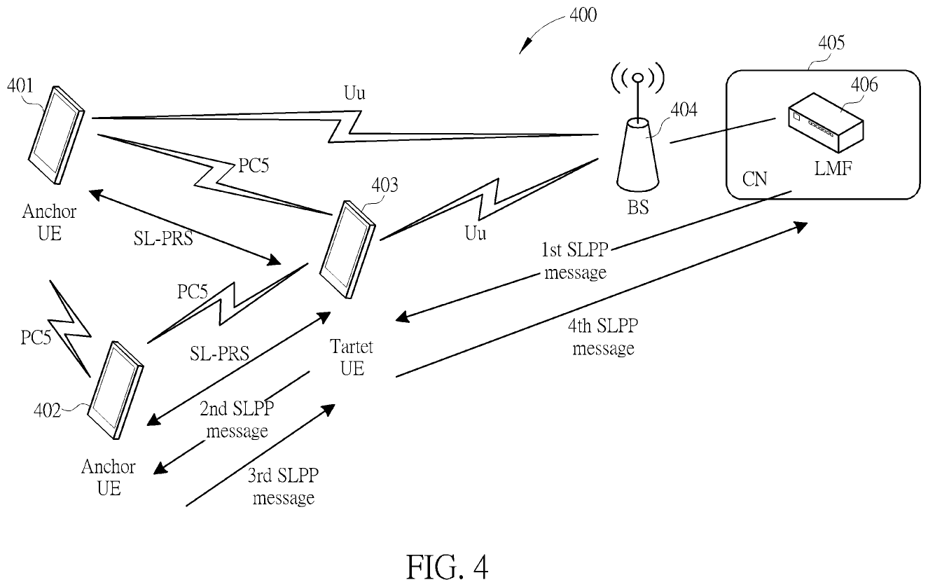

FIG. 4 illustrates a wireless system 400 showing another high-level solution based on the wireless system 200 depicted in FIG. 2. In the wireless system 400, the target UE 403 participates in forwarding information between the LMF 406 and the anchor UE 402. This process involves a series of SLPP message transmissions, enabling indirect communication between the LMF 406 and the anchor UE 402. The method comprises four distinct steps, each involving the transmission of an SLPP message.

The process begins with the LMF 406 sending a first SLPP message to the target UE 403. This message comprises information that is explicitly indicated as being directed to the anchor UE 402. The inclusion of this destination information is crucial, as it allows the target UE to recognize its role in the forwarding process.

Next, the target UE 403, having received and processed the first SLPP message, sends a second SLPP message to the anchor UE 402. This second message comprises the first information that was originally sent by the LMF 406. Essentially, the target UE 403 acts as an intermediary, relaying the information from the LMF 406 to the anchor UE 402. Note that the LMF 406 can be located in the CN 405.

The next step involves the anchor UE 402 sending a third SLPP message to the target UE. This message comprises second information that is indicated as being directed to the LMF 406. This step illustrates the bidirectional nature of the communication, allowing anchor UE 402 to respond or provide information back to the LMF 406.

In final step, the target UE 403 completes the exchange by sending a fourth SLPP message to the LMF 406. This message comprises the second information that was received from the anchor UE 402. Through this sequence of messages, the LMF 406 is able to exchange information with the anchor UE 402, despite the lack of direct communication between them.

This method provides a robust solution for scenarios where network topology or other constraints prevent direct communication between certain nodes. By leveraging the target UE as an intermediary, the system can maintain effective information exchange and coordination among all relevant parties in the sidelink positioning process.

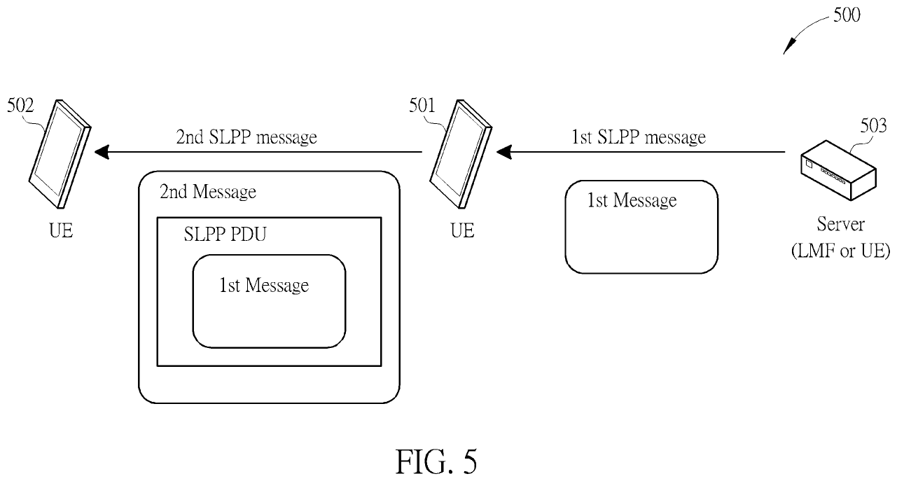

FIG. 5 illustrates an embodiment of an SLPP forwarding mechanism. This embodiment is presented in a simplified wireless system 500 comprising two UEs 501, 502 and a server 503. The method involves forwarding an entire SLPP message as a protocol data unit (PDU) within another SLPP message. This approach offers a straightforward solution to the forwarding challenge, albeit with certain trade-offs.

The process begins with the server 503, which may be an LMF or a server UE, sending a first SLPP message to the UE 501. This first SLPP message includes destination information indicating that it is intended for the UE 502. The inclusion of this destination information is critical, as it allows UE 501 to understand its role in the forwarding process without needing to interpret the entire contents of the message.

Upon receiving the first SLPP message, the UE 501 processes it to determine the intended recipient. Recognizing that the message is destined for the UE 502, the UE 501 then prepares to forward the message. Instead of extracting and repackaging the content, the UE 501 encapsulates the entire first SLPP message as a PDU within a second SLPP message.

Next, the UE 501 sends this second SLPP message to UE 502. The second message contains the complete first SLPP message as its payload, preserving all original information including the destination details. When the UE 502 receives this message, it can extract and process the original message from the server as if it had received it directly.

This approach offers several advantages. Primarily, it simplifies the processing required by the intermediary UE (e.g., UE 501 in this case). The UE 501 does not need to interpret or modify any portion of the first message beyond recognizing the destination information. This can be particularly beneficial in scenarios where the intermediary UE may not have the capability or authorization to process the content of the forwarding messages.

However, this method also comes with certain limitations. Since the entire original message is forwarded, including elements like the original destination information, there may be unnecessary data transmitted over the air. This could potentially impact network efficiency, especially in scenarios with limited bandwidth or when dealing with large volumes of messages.

Additionally, this approach does not allow for a single SLPP message to have different portions addressed to different UEs. Each forwarded message must be intended for a single recipient, which may not be ideal in all network configurations or use cases.

It should be noted that while FIG. 5 and description focus on the forward path (from the server 503 to the UE 502 via the UE 501), a similar mechanism can be employed for the reverse direction. In such a case, the UE 502 could send a message directed to the server 503, and the UE 501 would forward this message to the server 503 using the same PDU encapsulation method.

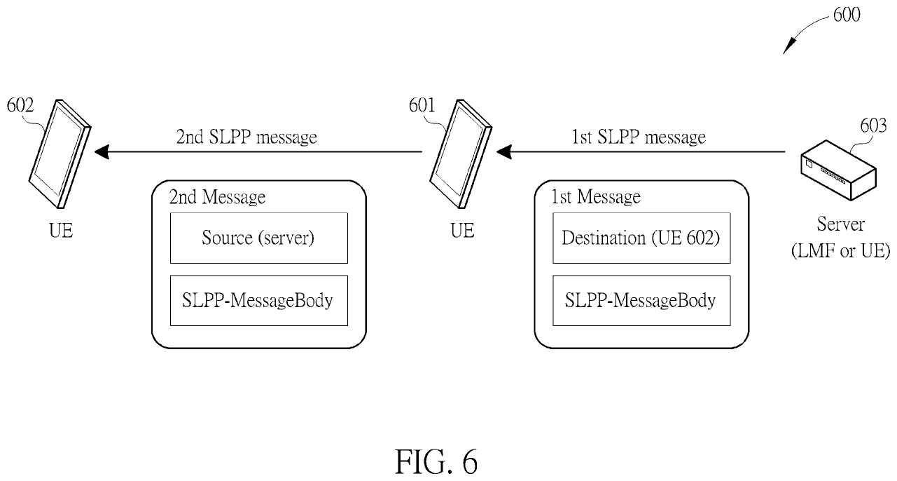

FIG. 6 illustrates an alternative embodiment of SLPP forwarding mechanism. This approach aims to address some of the limitations of the previous method by allowing for more selective forwarding of message content. In this mechanism, specific portions of an SLPP message are extracted by the intermediary UE and repackaged as part of a new SLPP message for transmission to the final recipient.

The process begins with the server 603, which may be an LMF or a server UE, sending a first SLPP message to the UE 601. This message comprises two key components: destination information indicating that the content is intended for UE 602, and a message body. The message body may be structured in a standardized format, such as an SLPP-MessageBody information element (IE) using Abstract Syntax Notation One (ASN.1) encoding.

Upon receiving this message, the UE 601 processes it to identify the intended recipient and extract the relevant content. Instead of forwarding the entire original message, the UE 601 prepares a new SLPP message for transmission to the UE 602.

Next, the UE 601 sends a second SLPP message to the UE 602. This new message comprises a copy of the message body from the original SLPP message. The message body in this second message may maintain the same structure and format as the original (e.g., an SLPP-MessageBody IE in ASN.1 format). The second SLPP message may also include additional source information, indicating that the content originated from the server. This source information allows the final recipient (i.e., the UE 602) to understand the origin of the message, which may be crucial for proper processing and response.

This method offers several advantages over the previous approach. By extracting and forwarding only the necessary content, it eliminates the transmission of unnecessary information over the air, such as the original destination information which is no longer needed once the message reaches the UE 601. This can lead to more efficient use of network resources, particularly in scenarios with constrained bandwidth or high message volumes.

As with the previous method, this approach can also be applied in the reverse direction, although this is not explicitly shown in the figure. In such a scenario, the UE 602 could send a third SLPP message with a message body directed to the server, and the UE 601 would extract the relevant content and forward it in a fourth SLPP message to the server 603.

While this method addresses the issue of forwarding unnecessary information, it still has a limitation. Since an SLPP message typically comprises only one message body, this approach does not allow for a single message to contain information intended for multiple destination UEs. This constraint may be significant in more complex network scenarios where efficient multi-point communication is required, as well as in scenarios where a plurality of UEs (for example, multiple anchor UEs) are out of direct communication with the server.

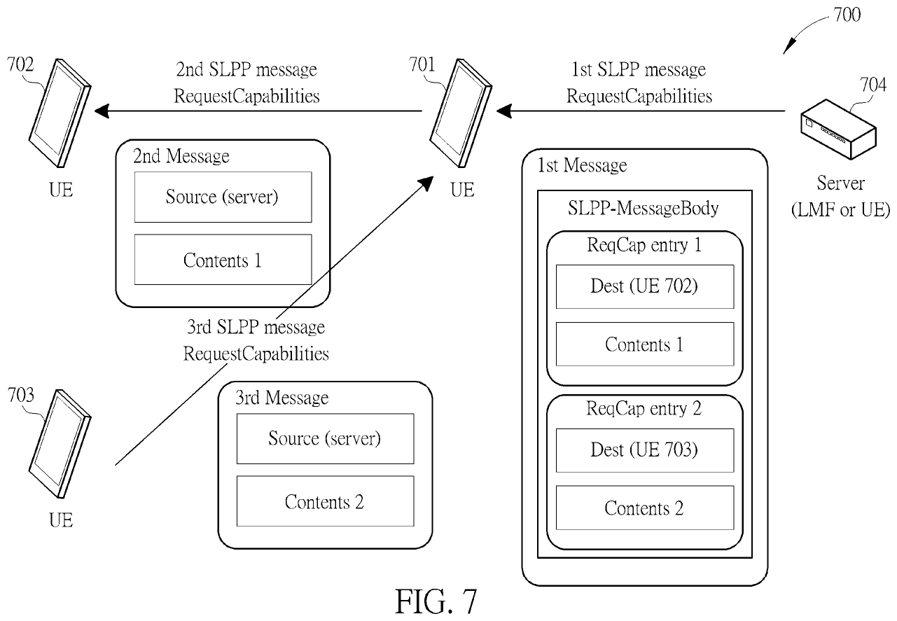

To address the limitations of the previous methods, a more flexible SLPP forwarding mechanism is illustrated in FIG. 7. This approach allows for multiple entries within a single SLPP message, each with its own destination information. The method is illustrated in a simplified wireless system 700 comprising three UEs 701, 702, 703 and a server 704 (which may be an LMF or a server UE), demonstrating its capacity to handle more complex communication scenarios.

In this mechanism, an SLPP message is associated with a particular transaction type. The figure uses capability exchange as an example, but it should be noted that this approach can be applied to various SLPP transaction types, such as assistance data transfer, location information transfer, error indication, and others.

The process begins with the server sending a first SLPP message to the UE 701. In the example shown, this is an SLPP Request Capabilities message, but the principle applies to other message types as well. The key feature of this message is its structure: it comprises a message body that contains multiple entries, each with its own destination information and content.

Specifically, the first SLPP message in this example contains two entries within its message body. The first entry, labeled “ReqCap entry 1,” includes destination information indicating it is intended for UE 702, along with a first set of message contents (labeled “Contents 1”) that are meant to be received and interpreted by UE 2. The second entry, labeled “ReqCap entry 2,” contains destination information specifying the UE 703 as the intended recipient, along with a second set of message contents (labeled “Contents 2”) for the UE 703.

When the UE 701 receives this first SLPP message, it processes the message to identify the multiple entries and their respective destinations. Recognizing that the two entries need to be delivered separately to their intended recipients, the UE 701 prepares to forward the information accordingly.

In the next step, the UE 701 sends a second SLPP message to the UE 702. This message is of the same type as the first SLPP message (e.g., in this case, an SLPP Request Capabilities message). The second message comprises a message body that includes two key elements. First, it contains source information indicating that the contents originated from the server, ensuring that the UE 702 understands the origin of the information. Second, it includes a copy of the first set of message contents (“Contents 1”) that were extracted from the first entry of the original message.

Similarly, the UE 701 then sends a third SLPP message to the UE 703. This message is also of the same type as the original message. The message body contains source information identifying the server as the origin of the content, along with a copy of the second set of message contents (“Contents 2”) extracted from the second entry of the original message.

This approach offers significant advantages in terms of flexibility and efficiency. It allows a single SLPP message to carry information intended for multiple recipients, which can be particularly useful in complex network scenarios or when coordinating activities across multiple UEs. The intermediary UE (e.g., the UE 701 in this case) can efficiently process and forward the relevant portions of the message to each intended recipient, reducing the number of transmissions required compared to sending separate messages for each recipient.

Furthermore, this method maintains the context and transaction type of the original message, ensuring that each recipient UE can process the information within the appropriate framework. The inclusion of source information in the forwarded messages also ensures that the recipients are aware of the origin of the information, which can be crucial for proper interpretation and response.

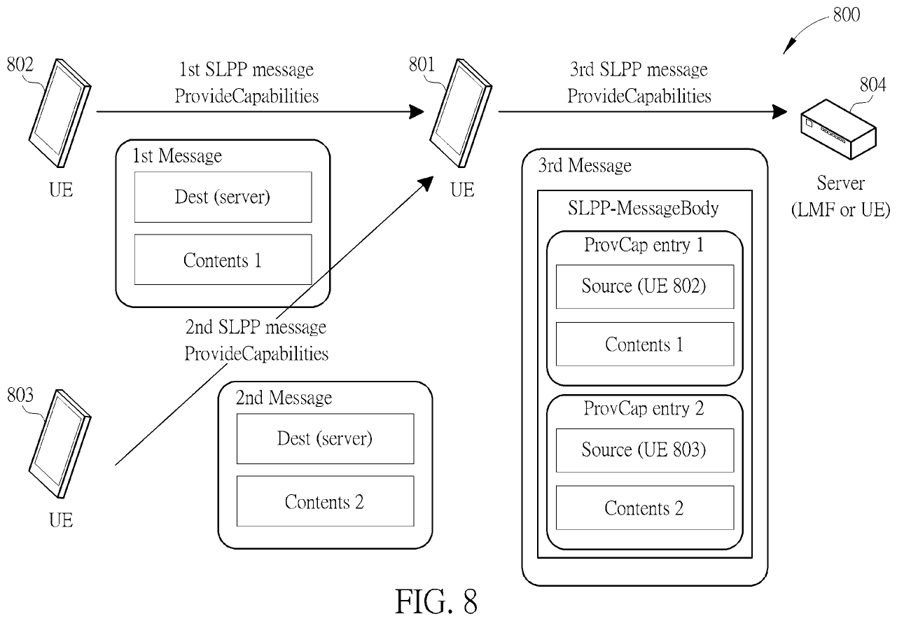

While the example in FIG. 7 illustrates the forwarding of information from a single source (the server 704) to multiple destinations (the UE 702 and the UE 703), the same principle can be applied in the reverse direction. FIG. 8 demonstrates this reverse scenario, where the UE 801 is responsible for forwarding information from multiple sources to a single destination.

The scenario depicted in FIG. 8 can be considered a response to the procedure illustrated in FIG. 7. In FIG. 8, the UE 801 acts as an intermediary for forwarding information from multiple sources (in this case, the UE 802 and the UE 803) to a single destination, the server 804 (which may be an LMF or a UE). This process involves multiple steps and demonstrates the flexibility of the SLPP forwarding mechanism in handling various communication patterns.

The process begins with the UE 802 sending a first SLPP message to the UE 801. In this example, the message is an SLPP Provide Capabilities message, but the principle can apply to other message types as well. This first message comprises a message body that contains two key elements: first destination information indicating that the contents are directed to the server 804, and a first set of message contents (labeled “Contents 1”).

In the next step, the UE 803 sends a second SLPP message to the UE 801. This message is also an SLPP Provide Capabilities message in this example. Similar to the first message, it comprises a message body with destination information specifying the server as the intended recipient, along with a second set of message contents (labeled “Contents 2”).

Upon receiving these messages, the UE 801 processes them and recognizes that both contain information intended for the same destination (the server). Instead of forwarding each message separately, the UE 801 prepares to consolidate the information into a single message for efficient transmission.

In the final step of this process, UE 801 sends a third SLPP message to the server. This message, like the previous ones, is an SLPP Provide Capabilities message in this example. The key feature of this message is its structure: its message body comprises two list entries, effectively combining the information from the two received messages.

The first entry in this consolidated message, labeled “ProvCap entry 1,” contains two elements: first source information indicating that its contents originated from UE 802, and a copy of the first set of message contents (“Contents 1”) from the message received from UE 2. Similarly, the second entry, labeled “ProvCap entry 2,” includes source information identifying UE 803 as the origin of its contents, along with a copy of the second set of message contents (“Contents 2”) from the message received from UE 803.

This approach offers several advantages. It allows for efficient consolidation of information from multiple sources into a single message, reducing the number of transmissions required and potentially conserving network resources. The inclusion of source information for each entry ensures that the server can distinguish between the information provided by different UEs, maintaining the context and origin of each piece of information.

However, it should be noted that in practical implementations, the first and second SLPP messages may not be delivered simultaneously to UE 801. This introduces a challenge: UE 801 needs to implement some form of processing to recognize when it should batch the contents together into a single outgoing message, rather than forwarding each received message individually.

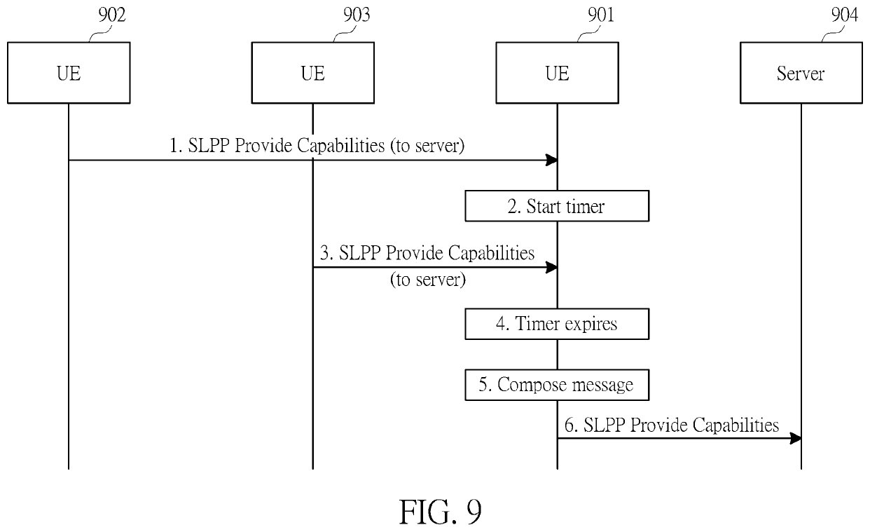

To address this challenge, FIG. 9 illustrates a timer-based approach for optimizing the forwarding process when messages are not received simultaneously. This method allows the UE to batch multiple received messages before forwarding them to the server, enhancing efficiency while ensuring timely delivery of information.

In step 1, the process begins when the UE 902 sends a first SLPP message (in this example, an SLPP Provide Capabilities message) to UE 901. In step 2, upon receiving this message, the UE 901 starts a timer. This timer serves as a mechanism to allow a window of time for potentially receiving additional messages before initiating the forwarding process.

While the timer is running, in step 3, the UE 903 sends a second SLPP message (also an SLPP Provide Capabilities message in this example) to the UE 901. The UE 901 receives and stores this SLPP message alongside the first SLPP message.

In step 4, after a predetermined period, the timer started by the UE 901 expires. This expiration serves as a trigger for the UE 901 to construct an outgoing message using the information received from both the UE 902 and the UE 903 during the timer period.

Following the timer expiration, in step 5, the UE 901 composes a third SLPP message. This message is structured in accordance with the principles described earlier: its message body comprises multiple list entries, each containing information from one of the received messages along with an indication of its source. In this case, the message would include a first entry with the information from the SLPP message of UE 902 and a second entry with the information from the SLPP message of UE 903.

Finally, in step 6, the UE 901 sends this third SLPP message to the server 904, effectively delivering the information from both the UE 902 and the UE 903 in a single transmission.

This timer-based approach offers flexibility and efficiency in handling message forwarding. It allows for the consolidation of multiple messages received within a short time frame, potentially reducing the number of transmissions and optimizing network resource usage. At the same time, the use of a timer ensures that information is not indefinitely delayed if no additional messages are received.

It should be noted that additional criteria can be incorporated into this process to further optimize its operation. For example, if UE 901 is triggered to send its own information to the server 904, it might immediately compose and send a message that includes both its own information and any stored information from received SLPP messages, without waiting for the timer to expire.

Another potential optimization involves delivery deadlines. One or both of the received SLPP messages might contain information indicating a delivery deadline. In such cases, the UE 901 could be programmed to compose and send the consolidated message at any time before the earliest deadline, ensuring timely delivery of time-sensitive information.

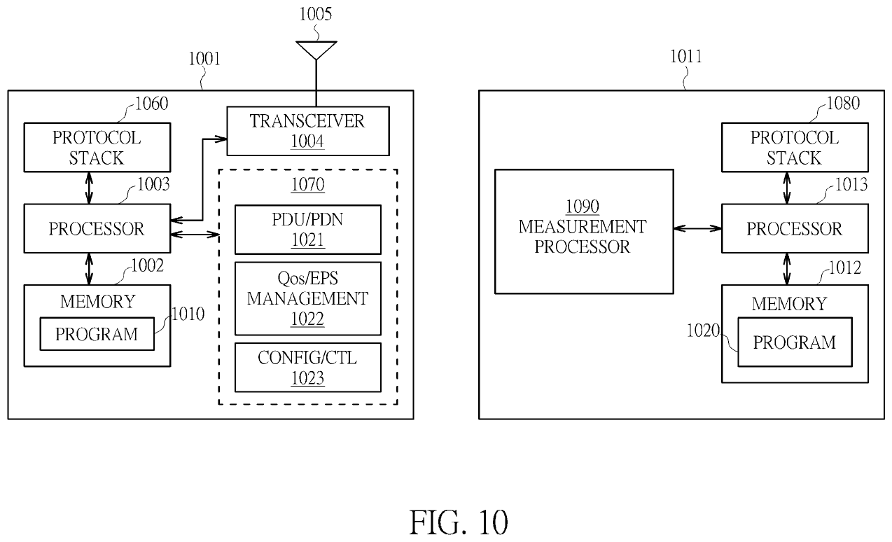

FIG. 10 illustrates a simplified block diagram of wireless devices, specifically a User Equipment (UE) 1001 and a network entity 1011 according to the embodiments. The network entity 1011, which may be implemented as a Location Management Function (LMF), comprises several key components. These include a memory 1012, a processor 1013, a protocol stack 1080 and a measurement processor 1090. The memory 1012 can be used for storing program instructions and data 1020 that control the operations of the network entity 1011. The processor 1013 can execute these program instructions to analyze and interpret positioning-related data transmitted through SLPP messages. It is responsible for extracting relevant information to determine or refine location estimates, processing various types of measurements that are crucial for accurate positioning in sidelink scenarios, such as time of arrival, angle of arrival, and signal strength indicators. It focuses on the efficient analysis of raw measurement data, transforming it into meaningful positioning information.

Functioning in conjunction with the processor 1013, the measurement processor 1090 specifically handles the processing of measurements received via SLPP. The protocol stack 1080 facilitates the standardized communication and data exchange between the network entity and other devices in the network, ensuring proper encapsulation, addressing, and routing of SLPP messages.

Collectively, these components form a comprehensive system for handling and analyzing positioning data in sidelink communications. The synergy between the processor 1013, memory 1012, and the measurement processor 1090 is crucial in enabling the system to perform precise location determination in device-to-device (D2D) and sidelink communication environments. By efficiently processing SLPP-transmitted measurements, this integrated system significantly contributes to the overall accuracy and reliability of the sidelink positioning system, providing a robust foundation for advanced location-based services and applications.

The UE 1001, in accordance with the embodiments, comprises a memory 1002, a processor 1003, and an RF transceiver 1004 coupled to an antenna 1005. The processor 1003, which may be implemented using various technologies such as digital signal processors (DSPs) or application specific integrated circuits (ASICs), processes received baseband signals and invokes different functional modules and circuits to perform features in the UE 1001. The memory 1002 stores data and program instructions 1010 executed by the processor 1003 to control UE operations.

The UE 1001 further includes a set of functional modules and control circuits 1070 and protocol stacks 1060. The protocol stacks 1060 comprise layers and/or sublayers such as Non-Access-Stratum (NAS), Radio Resource Control (RRC), Packet Data Convergence Protocol/Radio Link Control (PDCP/RLC), Media Access Control (MAC), and Physical (PHY). The system modules and circuits 1070 include a PDU session and PDN connection handling circuit 1021, a QoS flow and EPS bearer handling circuit 1022, and a configuration and control circuit 1023.

Regarding the protocol stacks 1080 and 1060, located in network entity 1011 and UE 1001 respectively, these protocol stacks implement a hierarchical framework of communication protocols, each layer performing specific functions to enable efficient and reliable data exchange. These protocol stacks ensure interoperability between different devices and systems by adhering to standardized protocols, thereby abstracting the complexities of network communication from higher-level applications.

In particular, the protocol stacks 1080 and 1060 integrate SLPP (also referred to as RSPP) and LTE Positioning Protocol (LPP). Hence, these protocol stacks also serve as essential components to manage a wide array of tasks crucial for effective positioning operations, particularly in D2D or sidelink communication scenarios. Their responsibilities encompass comprehensive message handling, implementation of various forwarding mechanisms, timer management, transaction processing, SL-PRS coordination, multi-UE communication facilitation, interface management, security implementation, interoperability assurance, and error handling. By executing these diverse functions, they enable efficient coordination of positioning operations, optimize communication processes, and ensure robust and accurate positioning capabilities across various network scenarios.

The various embodiments and optimizations provide a range of flexible and efficient solutions for SLPP message forwarding in diverse network configurations. By addressing the challenges of indirect communication in sidelink positioning systems, these methods enhance the overall functionality and efficiency of cellular networks, particularly in scenarios where direct communication between all nodes is not feasible.

Furthermore, the various embodiments offer significant advancements in wireless communication systems, particularly for sidelink positioning. The primary benefit lies in its enhanced flexibility, allowing communication between various network entities even without direct links, thus enabling positioning operations across a wider range of network topologies. The protocol's ability to facilitate indirect communication through intermediary UEs ensures effective information exchange in scenarios where direct communication is not feasible. This flexibility is coupled with efficient resource utilization, as the various forwarding mechanisms, especially those consolidating multiple messages, reduce unnecessary data transmission, optimizing network resource usage in bandwidth-constrained environments.

The protocol's support for complex communication patterns, including one-to-many and many-to-one scenarios, makes it particularly well-suited for coordinating positioning activities among multiple devices simultaneously. Its adaptability to various network conditions, including scenarios where messages are not received simultaneously, is enhanced by features like timer-based forwarding. The comprehensive functionality of the protocol, incorporating various transaction types within a single framework, streamlines the overall positioning process in cellular networks.

Furthermore, the invention improves scalability by allowing easy integration of additional UEs or network entities without significant reconfiguration. It enhances positioning accuracy by facilitating the exchange of detailed positioning information and capabilities between devices. The use of structured formats like ASN.1 ensures standardization, providing consistent and interoperable exchange of positioning-related information across different devices and implementations. Lastly, the extensible nature of the protocol future-proofs the system, allowing for the incorporation of new positioning methods or technologies as they develop. These collective benefits contribute to a more robust, efficient, and versatile positioning system in cellular networks, addressing current implementation challenges and paving the way for advanced location-based services and applications.

Furthermore, the various embodiments have wide-ranging applications in the field of wireless communication, with a particular focus on sidelink positioning in cellular networks. The primary use is in enhancing Device-to-Device (D2D) positioning, enabling more accurate and efficient location determination between devices without constant reliance on network infrastructure. This capability is especially valuable in scenarios where traditional positioning methods like GPS may be limited, such as indoor environments or urban areas with poor satellite visibility. The technology also significantly improves network coverage by allowing devices to relay positioning information, effectively extending the range of positioning services beyond direct base station coverage. This feature is particularly beneficial in rural or remote areas with sparse network infrastructure.

The applications extend to various sectors, including automotive, emergency services, Internet of Things (IoT), and smart city infrastructure. In Vehicle-to-Everything (V2X) communications, it enhances the precision and reliability of vehicle positioning, crucial for advanced driver assistance systems and autonomous driving technologies. For emergency services, the improved positioning capabilities aid in more accurate location of callers, especially in challenging environments. In IoT deployments, the protocol's efficient resource use and ability to handle multiple devices simultaneously make it ideal for tracking numerous low-power devices. The technology also has significant potential in urban planning and management, offering precise location data for public services, traffic management, and infrastructure monitoring. Additionally, its suitability for indoor navigation in large buildings, asset tracking in logistics, augmented reality applications, and network optimization for operators demonstrates its versatility and potential to significantly impact various industries by improving the accuracy, efficiency, and reliability of positioning services in diverse scenarios and environments.

In the context of the previously described embodiments and its various implementations, it is important to note that the Sidelink Positioning Protocol (SLPP) can also be referred to as the Ranging and Sidelink Positioning Protocol (RSPP). This alternative terminology reflects a comprehensive description of the protocol's capabilities (refer to 3GPP TS 23.586). Throughout the preceding discussion, wherever SLPP is mentioned, it can be understood that RSPP could be used interchangeably. This equivalence applies to all aspects of the protocol described earlier, including its structure, message types, transaction categories, and forwarding mechanisms.

It should be noted that this terminological flexibility does not alter the core functionalities or characteristics of the protocol as detailed in the previous descriptions. Whether referred to as SLPP or RSPP, the protocol maintains its capabilities in areas such as capability exchange, assistance data transfer, location information transfer, and error indication. Similarly, the protocol's adaptability to various network topologies and its support for complex communication patterns remain unchanged. In practical applications and future developments of this technology standard (i.e., 3GPP standards) both terms (SLPP and RSPP) may be encountered. Implementers, researchers, and users of the protocol should be aware of this dual nomenclature to avoid confusion and ensure clear communication when discussing or working with this positioning protocol.

For clarity in this specification, certain terminological conventions are observed. The singular forms “a”, “an”, and “the” are intended to encompass plural forms as well, unless the context clearly indicates otherwise. The term “and/or” refers to and encompasses any and all possible combinations of one or more of the associated listed items. The terms “includes,” “including,” “comprises,” and “comprising” specify the presence of stated features, integers, steps, operations, elements, and/or components, but do not preclude the presence or addition of one or more other features, integers, steps, operations, elements, components, and/or groups thereof.

The term “exemplary” is used herein to mean “serving as an example, instance, or illustration” and should not be construed as necessarily preferred or advantageous over other aspects or designs.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain voice or non-voice data/control information, regardless of whether these signals are analog or digital in nature.

In the context of this patent specification, the term “user equipment” (UE) encompasses a broad range of devices possessing radio communication capabilities. This definition includes, but is not limited to, smartphones (specifically, handheld touchscreen mobile computing devices capable of connecting to one or more cellular networks), Personal Data Assistants (PDAs), pagers, laptop computers, desktop computers, wireless handsets, and any computing device equipped with a wireless communications interface. User equipment may also be referred to by various alternative terms, including but not limited to: client, mobile device, mobile terminal, user terminal, mobile unit, mobile station, mobile user, subscriber, user, remote station, access agent, user agent, receiver, radio equipment, reconfigurable radio equipment, or reconfigurable mobile device. These terms should be considered interchangeable within the context of this document.

The scope of UEs also extends to Internet of Things (IoT) devices. IoT UEs are characterized by a network access layer specifically designed for low-power IoT applications that typically involve short-lived UE connections. These IoT UEs may employ various technologies for data exchange, including Machine-to-Machine (M2M), Machine Type Communication (MTC), or massive MTC (mMTC). Such data exchanges may occur with an MTC server or device via a Public Land Mobile Network (PLMN), with other UEs using Proximity Services (ProSe) or Device-to-Device (D2D) communications, or through sensor networks or IoT networks. It is noteworthy that M2M or MTC data exchanges are often initiated by the machine itself rather than by human intervention.

An IoT network, as referenced in this specification, describes an interconnected system of IoT UEs. These UEs may include uniquely identifiable embedded computing devices integrated within the broader Internet infrastructure. IoT UEs may execute background applications, such as keep-alive messages or status updates, to maintain and facilitate the connections within the IoT network.

UEs are configured to establish communicative coupling with Radio Access Networks (RANs) through a radio interface. This radio interface is a physical communication interface or layer designed to operate with various cellular communication protocols. These protocols may include, but are not limited to, Global System for Mobile Communications (GSM) protocol, Code Division Multiple Access (CDMA) network protocol, Push-to-Talk (PTT) protocol, PTT over Cellular (POC) protocol, Universal Mobile Telecommunications System (UMTS) protocol, 3rd Generation Partnership Project Long-Term Evolution (3GPP LTE) protocol, 5G protocol, and New Radio (NR) protocol.

As a specific example, a UE and a RAN may utilize a Uu interface (such as an LTE-Uu interface) to exchange control plane data. This exchange occurs via a protocol stack comprising multiple layers: a Physical (PHY) layer, a Medium Access Control (MAC) layer, a Radio Link Control (RLC) layer, a Packet Data Convergence Protocol (PDCP) layer, and a Radio Resource Control (RRC) layer. In this context, a Downlink (DL) transmission refers to data sent from the RAN to the UE, while an Uplink (UL) transmission refers to data sent from the UE to the RAN.

Furthermore, UEs may employ a sidelink for direct communication with other UEs, facilitating D2D, Peer-to-Peer (P2P), and/or ProSe communication. A ProSe interface, for instance, may incorporate one or more logical channels. These channels include, but are not limited to, a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The various aspects described herein may be implemented using a variety of hardware and software components. These may include processors, Digital Signal Processors (DSPs), Application Specific Integrated Circuits (ASICs), Field Programmable Gate Arrays (FPGAs) or other programmable logic devices, discrete gates or transistor logic, or discrete hardware components. A processor in this context may be a microprocessor, but could also be any conventional processor, controller, microcontroller, or state machine. Processors may also be implemented as combinations of computing devices, such as a combination of a DSP and a microprocessor, multiple microprocessors, one or more microprocessors in conjunction with a DSP core, or any other such configuration.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

In some embodiments, the computing instructions may be executed by an operating system, which may include but is not limited to Microsoft Windows, Apple Mac OS X, macOS, or iOS, various distributions of the Linux operating system, or Google Android operating system.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

In implementations where the systems described in this specification collect user information, provisions may be made to protect user privacy and data. Specifically, users may be afforded the opportunity to opt in or out of programs or features that collect personal information, such as data related to user preferences or smart device usage patterns. Furthermore, in certain embodiments, data protection measures may be implemented to anonymize collected information prior to storage or utilization. For instance, a user's identity may be anonymized to prevent the determination or association of personally identifiable information with that specific user. Additionally, user preferences and interaction data may be generalized, potentially based on broader demographic categories, rather than being linked to individual users.

It should be noted that the operational steps described in any exemplary aspects within this specification are provided as examples and for discussion purposes. These operations may be performed in numerous different sequences other than the illustrated sequences. Furthermore, operations described in a single step may actually be performed as multiple distinct steps, and multiple steps may be combined into a single operational step. The steps in the appended figures may be subject to numerous modifications as will be apparent to those skilled in the art.

Some embodiments may incorporate all explicitly disclosed features as well as additional features that, while not specifically described herein, are compatible with and enhance the core invention. Conversely, other embodiments may selectively omit certain non-disclosed elements, either partially or in their entirety, while still falling within the scope of the invention. This flexibility in feature inclusion or exclusion allows for a range of implementations tailored to specific applications or requirements, without departing from the fundamental principles of the invention.

The logical stages illustrated in the drawings may be reordered, combined, or broken out if they are not order-dependent. The ordering and groupings presented in this specification are not exhaustive, and other arrangements will be apparent to those skilled in the art. These stages may be implemented in hardware, firmware, software, or any combination thereof.

The drawings and descriptions provided in this specification offer detailed illustrations of various embodiments of the invention. However, it should be understood by those skilled in the art that these embodiments can be implemented without necessarily adhering to every specific detail provided herein. In some instances, well-established methods, procedures, components, and circuits have been mentioned without elaborate explanations to avoid obscuring the key aspects of the embodiments. It is important to note that the figures presented in this specification, including any component diagrams, are intended for illustrative purposes and may not be drawn to scale. This allows for a clear presentation of the inventive concepts while leaving room for variations and adaptations within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of message forwarding in a wireless system, comprising:
receiving a first message by a first node from a second node, the first message comprising a message body and an identifier for a third node;
identifying the third node as a destination by the first node according to the identifier for the third node; and
transmitting a second message by the first node to the third node, the second message comprising information associated with the first message and an identifier for the second node as a source;
wherein the first message and the second message are constructed using Sidelink Positioning Protocol (SLPP) or Ranging and Sidelink Positioning Protocol (RSPP).

2. The method of claim 1, wherein:
the first node is a first user equipment (UE);
the second node is a Location Management Function (LMF) or a second UE; and
the third node is the LMF or a third UE.

3. The method of claim 1, wherein the information associated with the first message comprises a protocol data unit (PDU), and the PDU comprises the first message.

4. The method of claim 1, wherein the information associated with the first message comprises a message body.

5. The method of claim 1, wherein the information associated with the first message comprises one or more information elements (IEs) associated with the first message.

6. The method of claim 1, further comprising:
receiving a third message by the first node from a fourth node, the third message comprising a message body and an identifier for the third node as a destination;
packaging information associated with the third message and an identifier for the fourth node as a source into a fourth message; and
transmitting the fourth message by the first node to the second node.

7. A method of message forwarding in a wireless system, comprising:
receiving a first message by a first node from a second node, the first message comprising a message body and an identifier for a third node;
initiating a countdown upon receipt of the first message by the first node;
identifying the third node as a destination by the first node according to the identifier for the third node; and
transmitting a second message by the first node to the third node when the countdown completes, the second message comprising information associated with the first message and an identifier for the second node as a source;
wherein the first message and the second message are constructed using Sidelink Positioning Protocol (SLPP) or Ranging and Sidelink Positioning Protocol (RSPP).

8. The method of claim 7 further comprising:
receiving a fourth message by the first node from a fourth node after initiating the countdown; and
packaging information associated with the fourth message into the second message.

9. The method of claim 8, wherein:
the first node is a first user equipment (UE);
the second node is a Location Management Function (LMF) or a second UE;
the third node is the LMF or a third UE; and
the fourth node is the LMF or a fourth UE.

10. The method of claim 7, wherein the information associated with the first message comprises a protocol data unit (PDU), and the PDU comprises the first message.

11. The method of claim 7, wherein the information associated with the first message comprises a message body.

12. The method of claim 7, wherein the information associated with the first message comprises one or more information elements (IEs) associated with the first message.

13. A user equipment (UE), comprising:
a memory; and
a processor coupled to the memory, configured to:
receive a first message from a second node;
identify a third node as a destination; and
transmit a second message to the third node;
wherein:
the first message and the second message are constructed using Sidelink Positioning Protocol (SLPP) or Ranging and Sidelink Positioning Protocol (RSPP);
the first message comprises a message body and an identifier for the third node as the destination; and
the second message comprises information associated with the first message and an identifier for the second node as a source.

14. The UE of claim 13, wherein:
the second node is a Location Management Function (LMF) or a second UE; and
the third node is the LMF or a third UE.

15. The UE of claim 13, wherein the information associated with the first message comprises a protocol data unit (PDU), and the PDU comprises the first message.

16. The UE of claim 13, wherein the information associated with the first message comprises a message body.

17. The UE of claim 13, wherein the information associated with the first message comprises one or more information elements (IEs) associated with the first message.

18. A user equipment (UE), comprising:
a memory; and
a processor coupled to the memory, configured to:
receive a first message from a second node;
initiate a countdown upon receipt of the first message;
identify a third node as a destination; and
transmit a second message to the third node when the countdown completes;
wherein:
the first message and the second message are constructed using Sidelink Positioning Protocol (SLPP) or Ranging and Sidelink Positioning Protocol (RSPP);
the first message comprises a message body and an identifier for the third node; and
the second message comprises information associated with the first message and an identifier for the second node as a source.

19. The UE of claim 18, wherein the processor is further configured to:
receive a fourth message from a fourth node after initiating the countdown; and
package information associated with the fourth message into the second message.

20. The UE of claim 19, wherein:
the second node is a Location Management Function (LMF) or a second UE;
the third node is the LMF or a third UE; and
the fourth node is the LMF or a fourth UE.
